(19) United States
(12) Patent Application Publication
(10) Pub. No.: US 2014/0198365 A1
(43) Pub. Date: Jul. 17, 2014

(54) MULTI-BEAM LASER SCANNING SYSTEM AND METHOD

(71) Applicant: General Electric Company, (US)

(72) Inventors: Yanmin Li, Shanghai (CN); Rui Guo, Shanghai (CN); Wen Tan, Waterloo (CA); Abdelaziz Ikhlef, Hartland, WI (US); Xiaobin Chen, Shanghai (CN); Guoshuang Cai, Shanghai (CN); Zhixue Peng, Shanghai (CN); Wenlong Xu, Shanghai (CN); Peng Li, Shanghai (CN)

(73) Assignee: General Electric Company, Schenectady, NY (US)

(21) Appl. No.: 13/851,305

(22) Filed: Mar. 27, 2013

(30) Foreign Application Priority Data
Mar. 30, 2012 (CN) 201210091314.8

(51) Int. Cl. G02B 26/12

(52) U.S. Cl. CPC G02B 26/123
USPC 359/201.2

(57) ABSTRACT

A multi-beam laser scanning system comprising a laser, a beam splitter, a first scanning unit, a second scanning unit, and a control unit is disclosed herein. The laser is used for generating an initial laser beam. The beam splitter is used for splitting the initial laser beam into a first laser beam and a second laser beam. The first scanning unit is used for deflecting the first laser beam along a desired direction. The second scanning unit is used for deflecting the second laser beam along a desired direction. The control unit is coupled to the first and second scanning units and arranged to output control signals to the first and second scanning units to manufacture an object.

### BACKGROUND OF THE INVENTION

Objects such as three-dimensional (3D) objects such as collimators used in x-ray imaging devices can be manufactured using laser rapid manufacturing (or free form fabrication) technology. One laser rapid manufacturing approach uses a laser beam to scan across and selectively polymerize a monomer (i.e., solidify a liquid plastic) to build up a prototype layer-by-layer and line-by-line from a predetermined model of a 3D object. The laser beam is focused on a portion of a bath of liquid resin which causes the liquid to polymerize (or solidify) where the focal point of the laser beam contacts (i.e., is incident on) the liquid. This technique allows a 3D object to be rapidly produced that would otherwise take a long time to make through a molding process.

Laser beams are used to perform selective laser sintering/melting of a powder in laser rapid manufacturing technology. Laser sintering/melting is a process in which the temperature of a powdered material is raised to its softening point by thermal heating with a laser beam, thereby causing the particles of the powder to fuse together in the heated region.

In the laser sintering/melting process, a deflected laser beam at a substantially constant power level is incident on a fabrication system and a lateral layer of an object is fabricated by repeated scanning of the laser beam in successive lines across a layer of powder until the entire layer has been scanned. The laser is turned on at points where the powder is to be sintered/melt; otherwise, the laser is off. When one layer is complete, the surface of the fabrication system is lowered, another layer of powder is spread over the previous, now sintered/melt layer, and the next layer is scanned. This process is repeated until the 3D object is complete. Laser rapid manufacturing technology uses one laser beam to manufacture objects and is limited efficiency.

### BRIEF DESCRIPTION OF THE INVENTION

In one embodiment, a multi-beam laser scanning system is provided. The system comprises a laser configured to generate an initial laser beam, and a beam splitter configured to split the initial laser beam into a first laser beam and a second laser beam. The system further comprises a first scanning unit configured to deflect the first laser beam along a desired direction, and a second scanning unit configured to deflect the second laser beam along a desired direction. A control unit is coupled to the first and second scanning units and arranged to output control signals to the first and second scanning units to manufacture an object.

In another embodiment, a multi-beam laser scanning system is provided. The system comprises a laser for generating an initial laser beam, a first beam splitter configured to split the initial laser beam into a first laser beam and a second laser beam, a second beam splitter configured to split the first laser beam into a third laser beam and a fourth laser beam, and a third beam splitter configured to split the second laser beam into a fifth laser beam and a sixth laser beam. The system further comprises a first scanning unit configured to deflect the third laser beam along a desired direction, a second scanning unit configured to deflect the fourth laser beam along a desired direction, a third scanning unit configured to deflect the fifth laser beam along a desired direction, and a fourth scanning unit configured to deflect the sixth laser beam along a desired direction. A control unit is coupled to the first to fourth scanning units and is arranged to output control signals to the first to fourth scanning units to manufacture an object.

In another embodiment, a method for multi-beam laser scanning is provided. The method includes generating an initial laser beam, splitting the initial laser beam into a first laser beam and a second laser beam, and deflecting the first and second laser beams along desired directions based on control signals, to manufacture an object.

In another embodiment, a method for multi-beam laser scanning is provided. The method includes generating an initial laser beam, splitting the initial laser beam into a first laser beam and a second laser beam, splitting the first laser beam into a third laser beam and a fourth laser beam, splitting the second laser beam into a fifth laser beam and a sixth laser beam, and deflecting the third to sixth laser beams along desired directions based on control signals, to manufacture an object.

### BRIEF DESCRIPTION OF THE DRAWINGS

Features and aspects of embodiments of the present invention will become better understood when the following detailed description is read with reference to the accompanying drawings in which like characters represent like parts throughout the drawings, wherein:

FIG. 1 is a schematic diagram of a multi-beam laser scanning system according to an embodiment applying in a laser rapid manufacturing device;

FIG. 2 is a schematic diagram of a multi-beam laser scanning system according to an embodiment, together with a fabrication powder bed;

FIG. 3 is a schematic diagram of an object in x-ray diagnosis by using a conventional medical imaging device including a collimator;

FIG. 4 is a schematic diagram of a collimator of FIG. 3; and

FIG. 5 is a schematic diagram of a laser sintering process for fabricating the collimator of FIG. 4.

### DETAILED DESCRIPTION OF THE INVENTION

Embodiments of the invention relate to a multi-beam laser scanning system for performing rapid manufacturing of objects, such as 3D objects. The multi-beam laser scanning system comprises a laser, a beam splitter, a first scanning unit, a second scanning unit, and a control unit. The laser is used for generating an initial laser beam. The beam splitter is used for splitting the initial laser beam into a first laser beam and a second laser beam. The first scanning unit is used for deflecting the first laser beam along a desired direction. The second scanning unit is used for deflecting the second laser beam along a desired direction. The control unit is coupled to the first and second scanning units and arranged to output control signals to the first and second scanning units to manufacture an object.

Unless defined otherwise, technical and scientific terms used herein have the same meaning as is commonly understood by one of ordinary skill. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items, and terms such as “front”, “back”, “bottom”, and/or “top”, unless otherwise noted, are merely used for convenience of description, and are not limited to any one position or spatial orientation. Moreover, the terms “coupled” and “connected” are not intended to distinguish between a direct or indirect coupling/connection between two components. Rather, such components may be directly or indirectly coupled/connected unless otherwise indicated.

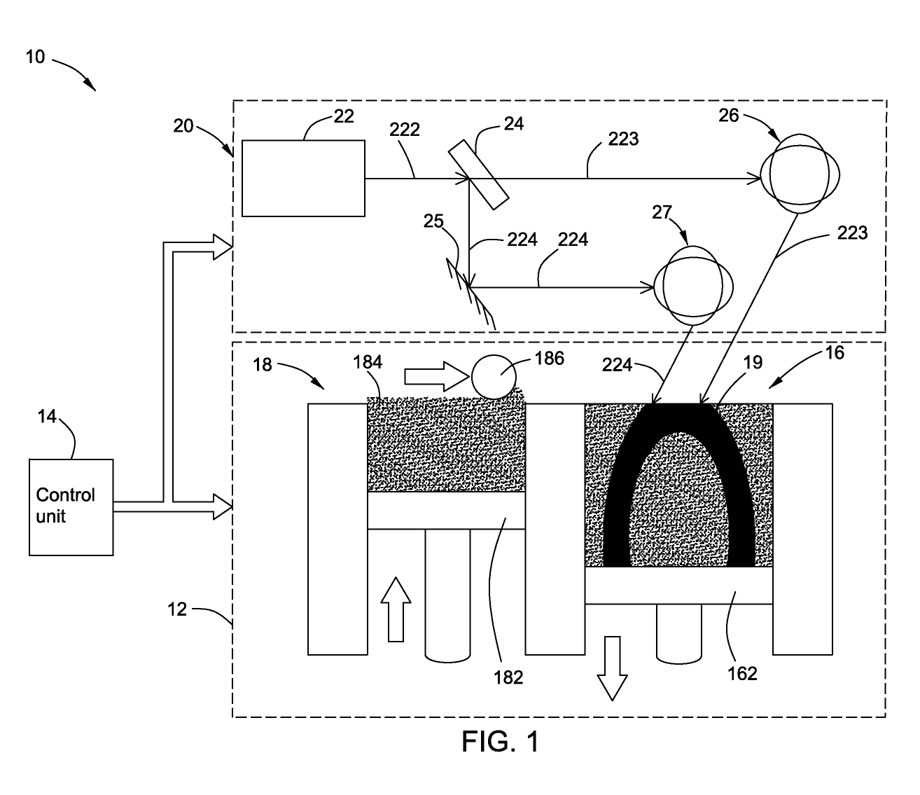

Referring to FIG. 1, a multi-beam laser scanning system 20 applying in a laser rapid manufacturing device 10 for rapid manufacturing of objects such as 3D objects is shown. The multi-beam scanning laser system 20 can be used in any laser rapid manufacturing device, such as a selective laser sintering/melting device shown in FIG. 1. In general, the multi-beam laser scanning system 20 can simultaneously output multiple laser beams by using only one laser. In other words, the multiple laser beams can simultaneously respectively fabricate different parts of a 3D object, which can increase efficiency.

Except for the multi-beam laser scanning system 20, the selective laser sintering/melting device 10 may further include a fabrication powder bed 12 and a control unit 14. The fabrication powder bed 12 may include a fabrication system 16 and a powder delivery system 18. The fabrication system 16 is located on a fabrication piston 162. The powder delivery system 18 includes a powder delivery piston 182, powder 184 located on the powder delivery piston 182, and a roller 186 used to push the powder 184 onto the fabrication piston 162 by controlling the powder delivery piston 182 and the fabrication piston 162 along the shown arrow direction according to control signals from the control unit 14. For example, control unit 14 may be a computer or a micro control.

The multi-beam laser scanning system 20 includes a laser 22, a beam splitter 24, a reflective mirror 25, a first scanning unit 26, and a second scanning unit 27. In an embodiment, the first scanning unit 26 and the second scanning unit 27 each may include a pair of scanning mirrors (not labeled).

The laser 22 is used to generate an initial laser beam 222 according to a control signal from the control unit 14. The beam splitter 24 is used to split the initial laser beam 222 into a first laser beam 223 and a second laser beam 224, and one 223 passes through the beam splitter 24 and the other one 224 is reflected by the beam splitter 24. In an embodiment, the first and second laser beams 223 and 224 have substantially the same laser power and beam quality. In other embodiments, the initial laser beam 222 can be split into two laser beams with different laser power or beam quality according to requirements for the laser beams.

In an embodiment, after splitting the laser beam 222, the second laser beam 224 is further reflected by the reflective mirror 25 to make sure the second laser beam 224 has substantially the same propagation direction with the first laser beam 223. In an embodiment, the second laser beam 224 can also have a different propagation direction with the first laser beam 223 according to requirements for the laser beams, and the reflective mirror 25 may be omitted in some embodiments. Subsequently, the substantially parallel first laser beam 223 and second laser beam 224 are respectively propagated to the first scanning unit 26 and the second scanning unit 27. The first scanning unit 26 is used to deflect the first laser beam 223 along desired direction according to control signals from the control unit 14, and the second scanning unit 27 is used to deflect the second laser beam 224 along desired direction according to control signals from the control unit 14. Thereby, the multi-beam laser scanning system 20 can simultaneously output two laser beams 223, 224 using only one laser 22, which can increase efficiency.

During a subsequent fabrication process, the two laser beams 223, 224 at a substantially constant power level are simultaneously incident on the fabrication system 16 and a lateral layer of an object 19 is fabricated by repeated scanning of the laser beams 223, 224 in successive lines across a layer of powder until the entire layer has been scanned. The laser 22 is turned on at points where the powder is to be sintered/melt; otherwise, the laser 22 is off. When one layer is complete, the surface of the fabrication system 16 is lowered, another layer of powder is spread over the previous, now sintered/melt layer, and the next layer is scanned. This process is repeated until the 3D object 19 is complete. In an embodiment, the propagated paths of the laser beams 223, 224 may include switching elements used to turn on/off the propagation of the laser beams 223, 224 according to control signals from the control unit 14.

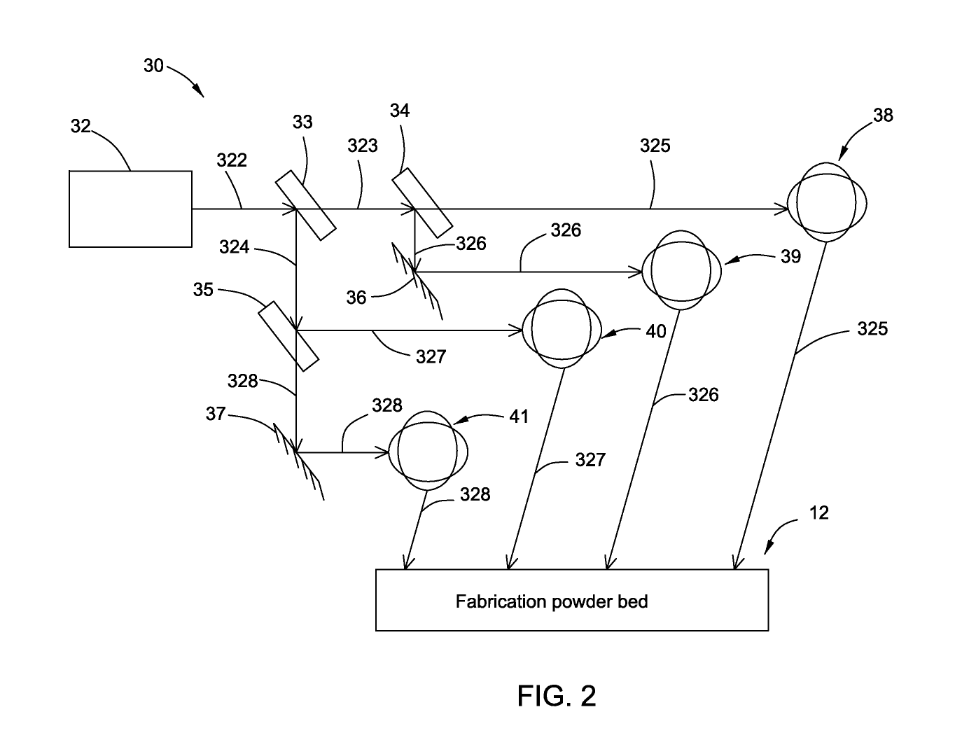

Referring to FIG. 2, an exemplary multi-beam laser scanning system 30 for rapid manufacturing of 3D objects, together with a fabrication powder bed 12 is shown. The multi-beam laser scanning system 30 includes a laser 32, a first beam splitter 33, a second beam splitter 34, a third beam splitter 35, a first reflective mirror 36, a second reflective mirror 37, a first scanning unit 38, a second scanning unit 39, a third scanning unit 40, and a fourth scanning unit 41.

In FIG. 2, the laser 32 is used to generate an initial laser beam 322. The first beam splitter 33 is used to split the initial laser beam 322 into a first laser beam 323 and a second laser beam 324. The first laser beam 323 passes through the beam splitter 33 and the second laser beam 324 is reflected by the beam splitter 33. The first laser beam 323 is further split by the second beam splitter 34 into a third laser beam 325 and a fourth laser beam 326. The fourth laser beam 326 is further reflected by the first reflective mirror 36 to make sure the fourth laser beam 326 has the same propagation direction with the third laser beam 325. The second laser beam 324 is further split by the third beam splitter 35 into a fifth laser beam 327 and a sixth laser beam 328. The sixth laser beam 328 is further reflected by the second reflective mirror 37 so that the sixth laser beam 328 has approximately the same propagation direction as the fifth laser beam 327.

Subsequently, the parallel third to sixth laser beams 325, 326, 327, 328 are respectively propagated to the first-fourth scanning units 38, 39, 40, 41. The first to fourth scanning units 38, 39, 40, 41 are used to respectively deflect the third to sixth laser beams 325, 326, 327, 328 along desired direction(s) according to control signals from the control unit 14 (not shown in FIG. 2). Thereby, the multi-beam laser scanning system 30 can simultaneously output four laser beams 325, 326, 327, 328 using only one laser 32, which can increase efficiency. The two embodiments of FIG. 1 and FIG. 2 are examples for explaining the principle of the multi-beam laser scanning system, the number of the output laser beams also can be increased by adding appropriate number of beam splitters, reflective mirrors, scanning units, and other appropriate optical elements.

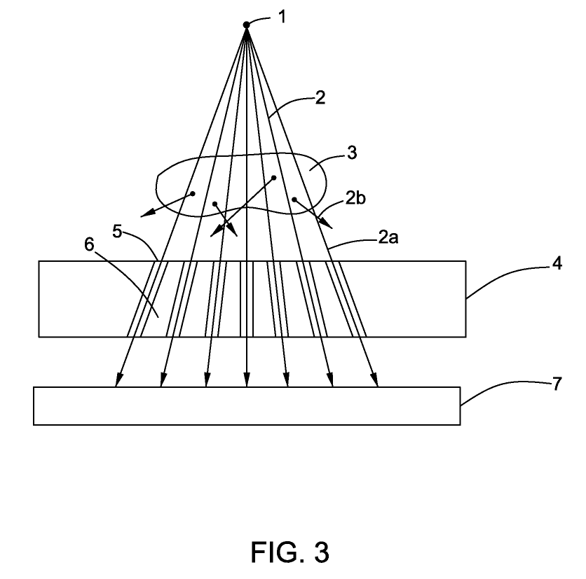

In an embodiment, the multi-beam laser scanning systems 20 and 30 can fabricate a collimator used in a medical imaging device. The situation of recording an x-ray image of an object 3 in x-ray diagnosis is represented schematically with the aid of FIG. 3. The object 3 lies between the tube focus 1 of an x-ray tube, which may be regarded as an approximate point x-ray source, and a detector surface 7. The x-rays 2 emitted from the focus 1 of the x-ray source propagate in a straight line in the direction of the x-ray detector 7, and in doing so pass through the object 3. The primary beams 2a striking the detector surface 7, which pass through the object 3 on a straight line starting from the x-ray focus 1, cause on the detector surface 7 a positionally resolved attenuation value distribution for the object 3. Some of the x-ray beams 2 emitted from the x-ray focus 1 are scattered in the object 3. The scattered beams 2b created in this case do not contribute to the desired image information and, when they strike the detector 7, significantly impair the signal-to-noise ratio. In order to improve the image quality, a collimator (or collimator array, or 2D collimator) 4 is therefore arranged in front of the detector 7.

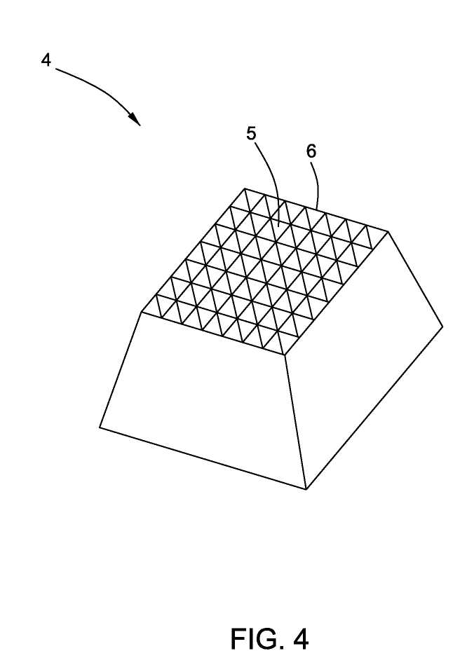

With reference to FIG. 4, the collimator 4 includes transmission channels 5 and absorbing regions 6 forming a grid arrangement. The transmission channels 5 are aligned in the direction of the tube focus 1, so that they allow the incident primary radiation 2a on a straight-line path to strike the detector surface. Beams not incident in this direction, such as the scattered beams 2b, are blocked or substantially attenuated by the absorbing regions 6. According to the above disclosure, the multi-beam laser scanning system (20, 30) can be used in laser rapid manufacturing technology to fabricate the collimator with a higher efficiency.

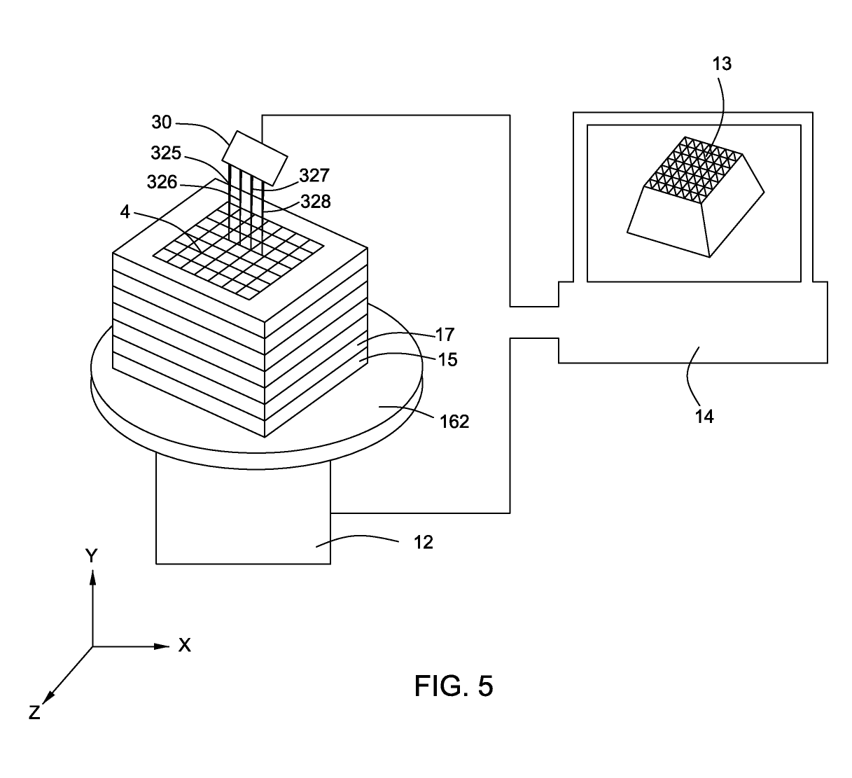

Referring to FIG. 5, a schematic diagram of a laser sintering process for fabricating the collimator 4 of FIG. 4 is shown. Therein, particles of a radiation-absorbing material for fabricating the collimator 4 are placed on a fabrication piston 162. The fabrication piston 162 is positioned in a fabrication powder bed 12 and can be moved in the y-direction. Using the multi-beam laser scanning system 30 to generate the separated third to sixth laser beams 325, 326, 327, 328 controlled such that the locations of the focus of the third to sixth laser beams 325, 326, 327, 328 are scanned in x-direction and z-direction over the surface of the substrate in accordance with a 3D collimator model 13 stored in a control unit 14 connected both to the multi-beam laser scanning system 30 and the fabrication powder bed 12. After having scribed a first layer 15 of sintered particles, the fabrication piston 162 is moved downwards, and the particles can be again evenly distributed over the surface of the already existing sintered structure and a second layer 17 of sintered particles can be generated using the third to sixth laser beams 325, 326, 327, 328. Accordingly, the 3D collimator model 13 stored in the control unit 14 may be reproduced by sintering particles layer-by-layer with very fast speed due to using four laser beams at the same time. Moreover, the four laser beams are generated from only one laser, not from four lasers, which can save money as well.

The above collimator (or called grid) 4 only shows an example for explaining what products the multi-beam laser scanning system (20, 30) may fabricate appropriately, and is not intended to limit the utility of the multi-beam laser scanning system (20, 30). For example, the multi-beam laser scanning system (20, 30) also can fabricate large 3D objects with high geometry accuracy, especially for large 3D objects with small features. By applying the multi-beam laser printing process, each laser beam covers a small scanning area (such as a center or a corner) so that higher and more consistent resolutions for the whole scanning area can be achieved easily and with more accuracy. Moreover, the multi-beam laser printing process can solve the beam floating issue of single laser beam technology for a large scanning area. The beam floating issue, which concerns the repositioning accuracy of the optic scanning system, is usually more serious for larger scanning areas. So, by applying the multi-beam laser scanning method, the beam floating issue can be improved.

While exemplary embodiments of the invention have been described herein, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A multi-beam laser scanning system, comprising:
a laser configured to generate an initial laser beam;
a beam splitter configured to split the initial laser beam into a first laser beam and a second laser beam;
a first scanning unit configured to deflect the first laser beam along a desired direction;
a second scanning unit configured to deflect the second laser beam along a desired direction; and
a control unit coupled to the first and second scanning units and arranged to output control signals to the first and second scanning units to manufacture an object.

2. The multi-beam laser scanning system of claim 1, further comprising a reflective mirror configured to reflect the second laser beam before the second laser beam is deflected by the second scanning unit.

3. The multi-beam laser scanning system of claim 2, wherein the reflective mirror reflects the second laser beam to position the first and second laser beams substantially parallel to each other.

4. The multi-beam laser scanning system of claim 1, wherein the first and second laser beams have substantially the same laser power and beam quality.

5. The multi-beam laser scanning system of claim 1, wherein the object is a grid-shaped collimator.

6. A multi-beam laser scanning system, comprising:
a laser configured to generate an initial laser beam;
a first beam splitter configured to split the initial laser beam into a first laser beam and a second laser beam;
a second beam splitter configured to split the first laser beam into a third laser beam and a fourth laser beam;
a third beam splitter configured to split the second laser beam into a fifth laser beam and a sixth laser beam;
a first scanning unit configured to deflect the third laser beam along a desired direction;
a second scanning unit configured to deflect the fourth laser beam along a desired direction;
a third scanning unit configured to deflect the fifth laser beam along a desired direction;
a fourth scanning unit configured to deflect the sixth laser beam along a desired direction; and
a control unit coupled to the first, second, third, and fourth scanning units and arranged to output control signals to the first, second, third, and fourth scanning units to manufacture an object.

7. The multi-beam laser scanning system of claim 6, further comprising:
a first reflective mirror configured to reflect the fourth laser beam before the fourth laser beam is deflected by the second scanning unit; and
a second reflective mirror configured to reflect the sixth laser beam before the sixth laser beam is deflected by the fourth scanning unit.

8. The multi-beam laser scanning system of claim 7, wherein the first reflective mirror reflects the fourth laser beam to position the third and fourth laser beams substantially parallel to each other, wherein the second reflective mirror reflects the sixth laser beam to position the fifth and sixth laser beams substantially parallel to each other.

9. The multi-beam laser scanning system of claim 6, wherein the third, fourth, fifth, and sixth laser beams have substantially the same laser power and beam quality.

10. The multi-beam laser scanning system of claim 6, wherein the object is a grid-shaped collimator.

11. A method of multi-beam laser scanning, the method comprising:
generating an initial laser beam;
splitting the initial laser beam into a first laser beam and a second laser beam; and
deflecting the first and second laser beams along a desired direction based on control signals to manufacture an object.

12. The multi-beam laser scanning method of claim 11, further comprising reflecting the second laser beam before the second laser beam is deflected.

13. The multi-beam laser scanning method of claim 12, wherein reflecting the second laser beam before the second laser beam is deflected comprises reflecting the second laser beam to position the first and second laser beams substantially parallel to each other.

14. The multi-beam laser scanning method of claim 11, wherein the first and second laser beams have substantially the same laser power and beam quality.

15. The multi-beam laser scanning method of claim 11, wherein the object is a grid-shaped collimator.

16. A method of multi-beam laser scanning, the method comprising:
generating an initial laser beam;
splitting the initial laser beam into a first laser beam and a second laser beam;
splitting the first laser beam into a third laser beam and a fourth laser beam;
splitting the second laser beam into a fifth laser beam and a sixth laser beam; and
deflecting the third, fourth, fifth, and sixth laser beams along a desired direction based on control signals to manufacture an object.

17. The multi-beam laser scanning method of claim 16, further comprising:
reflecting the fourth laser beam before the fourth laser beam is deflected; and
reflecting the sixth laser beam before the sixth laser beam is deflected.

18. The multi-beam laser scanning method of claim 17, wherein reflecting the fourth laser beam before the fourth laser beam is deflected comprises reflecting the fourth laser beam to position the third and fourth laser beams substantially parallel to each other, and wherein reflecting the sixth laser beam before the sixth laser beam is deflected comprises reflecting the sixth laser beam to position the fifth and sixth laser beams substantially parallel to each other.

19. The multi-beam laser scanning method of claim 16, wherein the third, fourth, fifth, and sixth laser beams have substantially the same laser power and beam quality.

20. The multi-beam laser scanning method of claim 16, wherein the object is a grid-shaped collimator.
